(19) United States
(12) Patent Application Publication
(10) Pub. No.: US 2026/0021940 A1
(43) Pub. Date: Jan. 22, 2026

(54) Barcode Blocking Bag

(71) Applicant: Johnathan Swart, Corona, CA (US)

(72) Inventor: Johnathan Swart, Corona, CA (US)

(21) Appl. No.: 19/033,360

(22) Filed: Jan. 21, 2025

Related U.S. Application Data
(60) Provisional application No. 63/623,802, filed on Jan. 22, 2024.

(51) Int. Cl. B65D 33/00; G06K 19/06

(52) U.S. Cl. CPC B65D 33/004; G06K 19/06028

(57) ABSTRACT

A code blocking bag for the shipment or processing of items with a barcode or other scannable code having a design that prevents the scanning of codes affixed to items within the bag while permitting the identification or inspection of the items.

### CROSS-REFERENCE TO RELATED APPLICATIONS

Priority claimed to Provisional Application No. 63/623,802

### STATEMENT REGARDING FEDERALLY SPONSORED RESEARCH OR DEVELOPMENT

Not Applicable

### TECHNICAL FIELD

The invention relates to the field of packaging for shipping, especially printed poly bags that block scannable codes on items within the bags.

### BACKGROUND OF THE INVENTION

E-commerce and the purchase of goods from online retailers and wholesalers is an increasingly ubiquitous part of modern consumer life. Websites like Amazon.com and Walmart.com offer hundreds of thousands of products for purchase with the click of a mouse or swipe of a smartphone.

Unlike more traditional forms of consumer activity, where the purchaser travels to a “brick and mortar” store, selects an item within, pays for the item at a cashier, and then physically transports the item home, the selection and purchase of a product online is only an initial step in its actual physical acquisition. Once a product is purchased online the seller must, among other things, select the product from its inventory, package the product for shipment, affix a label to the package indicating its destination, and ensure the product is shipped to the purchaser via standard mail, UPS, or other shipping provider.

Large online marketplaces, such as Amazon.com, ship over a million packages per day from a broad range of online sellers. Because of the need for uniformity and efficiency in picking, packaging, and shipping products, online marketplaces often have detailed terms and stipulations sellers must meet in order to conform to logistical and regulatory requirements of the marketplace and shipping providers. For example, sellers cannot ship hazardous materials, goods that exceed certain weight and size limits, and goods that violate legal prohibitions.

Many online marketplaces require that shipped products be enclosed in transparent, sealable “poly bags” to protect against leakage, damage, or contamination. Such bags are nearly ubiquitous in the realm of online commerce. Poly bags are typically clear bags made from various plastic materials, including polyethylene, polypropylene, and polyvinyl chloride. They are available in multiple sizes, thicknesses, and styles, rendering them useful for securing a wide variety of items prior to shipment. The poly bags required by online marketplaces must generally meet various requirements. For example, Amazon.com requires, among other things, that poly bags have a thickness of 1.5 mils (0.0015 of an inch), be sealed, be transparent, and have a suffocation warning if the opening is 5″ or wider.

Amazon's FNSKU (Fulfillment Network Stock Keeping Unit) barcode is assigned to products warehoused and shipped by Fulfillment by Amazon (“FBA”), which is used by more than 70% of Amazon.com sellers. The FNSKU is a unique identifier that typically starts with “X0”. The FNSKU identifies both the product and the seller and is scanned by Amazon when a shipment moves or is processed within an Amazon warehouse after sale. Among other things, the FNSKU ensures that a specific product is associated with a specific seller and not commingled in a warehouse with all products bearing the same UPC/EAN code. Additionally, if the product comprises a loose item, such as a towel, or a set of items, such as group of school supplies, the poly bag must typically have a FNSKU code in order to be scanned, processed, and fulfilled by Amazon.

A difficulty with Amazon's FNSKU and similar scannable marketplace-specific codes is that sellers typically have to obscure or cover the existing UPC/EAN product codes to ensure the FNSKU is scanned and not the UPC/EAN or other code. This can be done by drawing a line through the original barcode, covering it with a blank sticker, or covering it with a sticker containing the FNSKU code. Among other things, obscuring or covering an item's existing barcode involves additional processing by the seller and increased expense. Also, if the seller places the FNSKU on the outside of the poly bag securing the product and fails to obscure the original UPC/EAN or other code, they run the risk of their package being mis-scanned, potentially interfering with tracking of inventory and revenue. Additionally, sellers have expressed concern about whether covering or obscuring the existing product UPC/EA code could be regarded as a form of adulteration or indicate potential counterfeiting.

A further difficulty arises when selling multiple items with barcodes as a set. Even if the poly bag containing the items is affixed with the appropriate FNSKU or similar unique seller code, the online marketplace's scanning process may scan one of the items in the set and not the appropriate FNSKU or similar unique code associated with the bundle. Multiple items will thus each need to have their existing UPC/EAN codes obscured, even though only a single item set is being sold by the seller, thereby increasing the seller's expense.

### SUMMARY OF THE INVENTION

Applicant has invented new type of poly bag that blocks existing UPC/EAN, QR, or other barcodes on an item or items within the poly bag while still being sufficiently transparent that the item or items within the poly bag are visually identifiable.

According to the present invention, a standard poly bag is printed with a pattern or patterns that prevents scanning, whether by a human or automated system, of UPC/EAN, QR, or other barcodes affixed to an item or items within the bag. This ensures that only the barcode used by a particular online marketplace seller, such as Amazon's FNSKU code, will be captured by the scanning process, thereby ensuring information concerning a seller's inventory, revenue, and other information tracked by the marketplace code is reliably captured.

Among other things, advantages of the present invention are that it prevents mis-scanning of items or sets of items, reduces the need to obscure or sticker-over existing UPC/EAN or other barcodes affixed to items by the manufacturer or other source, and does not require any processing of items shipped within poly bags beyond simple placement within the bags.

The inventor has discovered a variety of patterns are effective for preventing the scanning of barcodes affixed to items within the blocking poly bags while maintaining sufficient transparency to permit identification of the items therein. In general, as illustrated in FIGS. 1-4, a pattern of lines of different orientations printed on poly bags has been found sufficient to prevent the scanning of barcodes on items contained within the poly bags. That the bags remain sufficiently transparent to permit identification of their contents is required by some online marketplaces, is desirable for sellers placing items within bags prior to shipment to the warehouse of an online marketplace, may be required by some shippers, and is believed to be aesthetically pleasing for consumers.

In a preferred embodiment, applicant has found that the “starburst” design depicted in FIG. 1 is effective for blocking the scanning of barcodes of items, maintaining sufficient transparency to permit ready identification of the items, and having desired aesthetic appeal.

Alternative embodiments depicted in FIGS. 2, 3, and 4 are also effective at blocking the barcodes of items contained therein while retaining sufficient transparency.

### BRIEF DESCRIPTION OF THE DRAWINGS

A more complete and thorough understanding of the present embodiments and advantages thereof may be acquired by referring to the following description taken in conjunction with the accompanying drawings, wherein:

FIG. 1 illustrates an embodiment of the present invention with a starburst pattern.

FIG. 2 illustrates an embodiment of the present invention with an ornamental pattern.

FIG. 3 illustrates an embodiment of the present invention with a diamond pattern.

FIG. 4 illustrates an embodiment of the present invention with a heavy ornamental pattern.

### DETAILED DESCRIPTION OF THE DRAWINGS

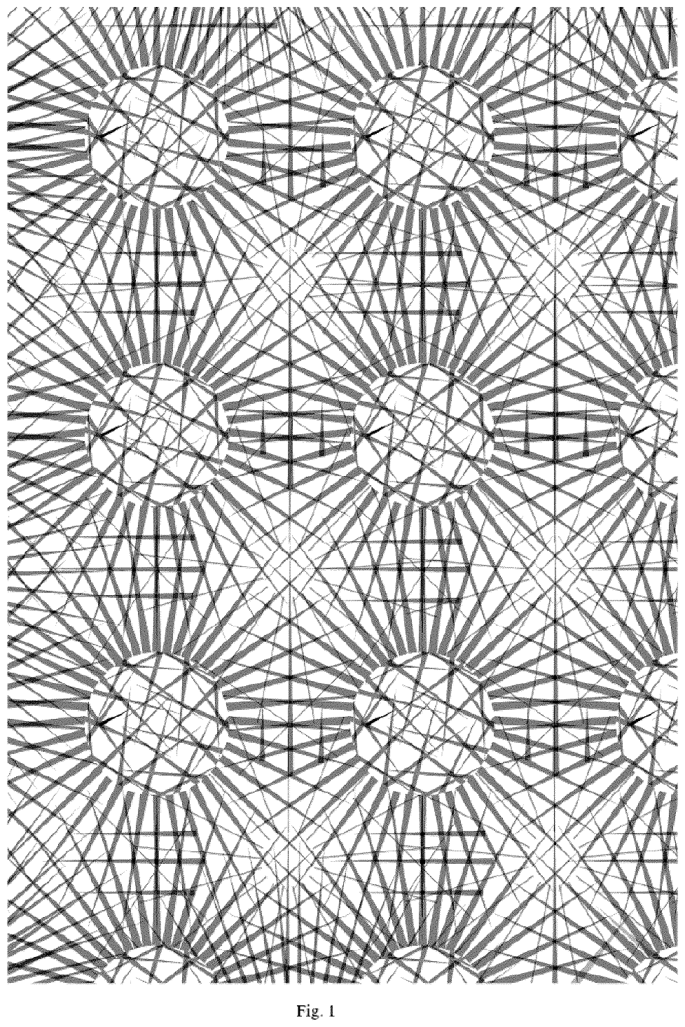

One embodiment of the present invention is illustrated in FIG. 1, which depicts a barcode blocking poly bag with a starburst pattern in the size of 14×20 inches. Printed on the bag is a suffocation warning, which is required by Amazon.com, and printed instructions not to separate the items therein.

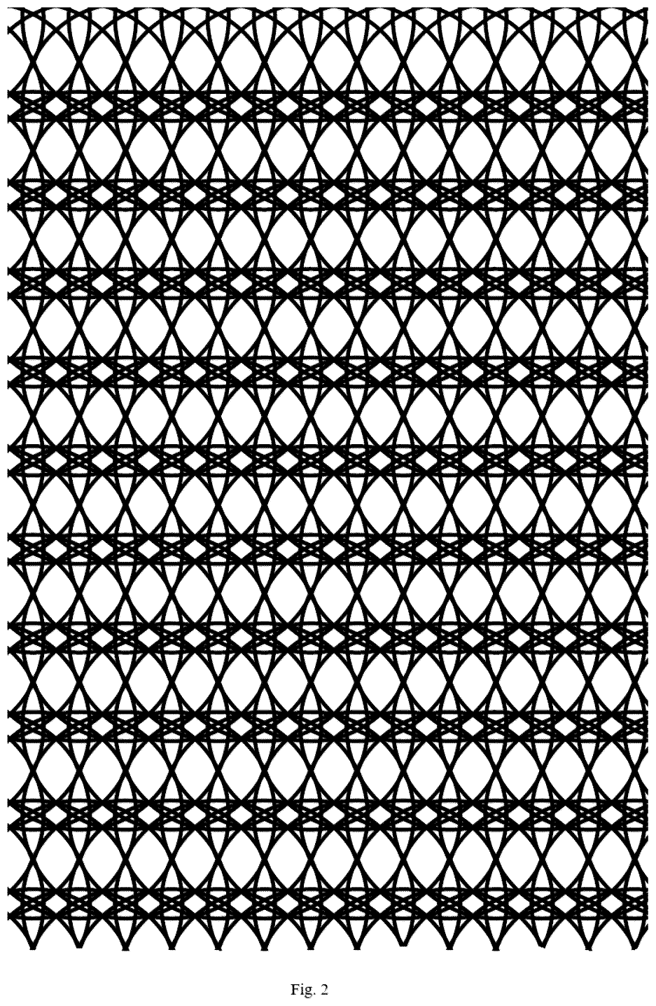

FIG. 2 illustrates an embodiment of the present invention and depicts a barcode blocking poly bag with an ornamental pattern in the size of 14×20 inches. Printed on the bag is a suffocation warning and printed instructions.

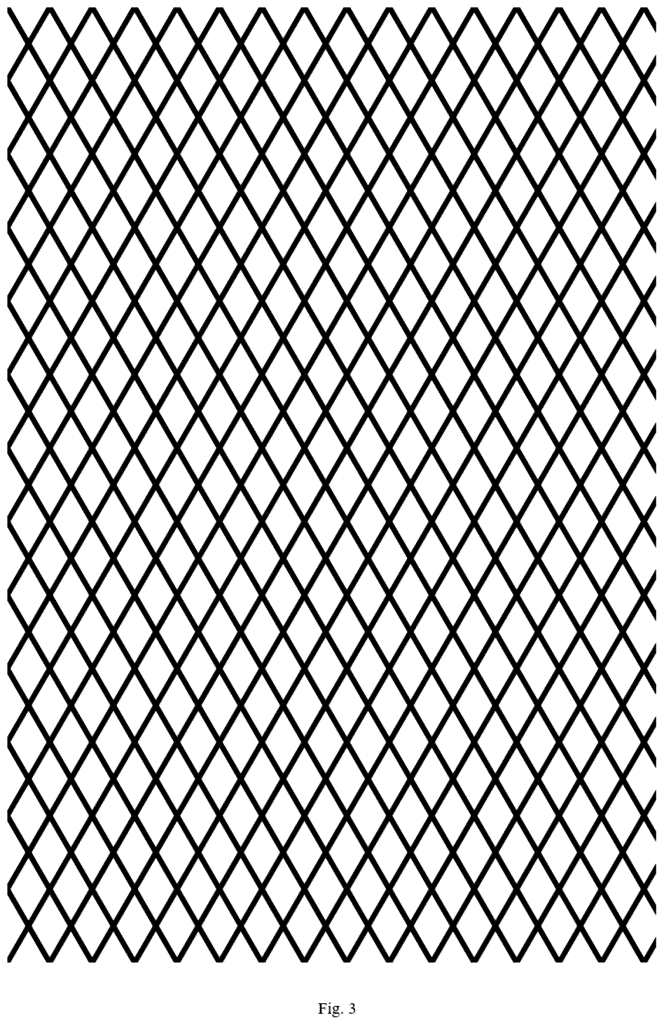

FIG. 3 illustrates an embodiment of the present invention and depicts a barcode blocking poly bag with a diamond pattern in the size of 14×20 inches. Printed on the bag is a suffocation warning and printed instructions.

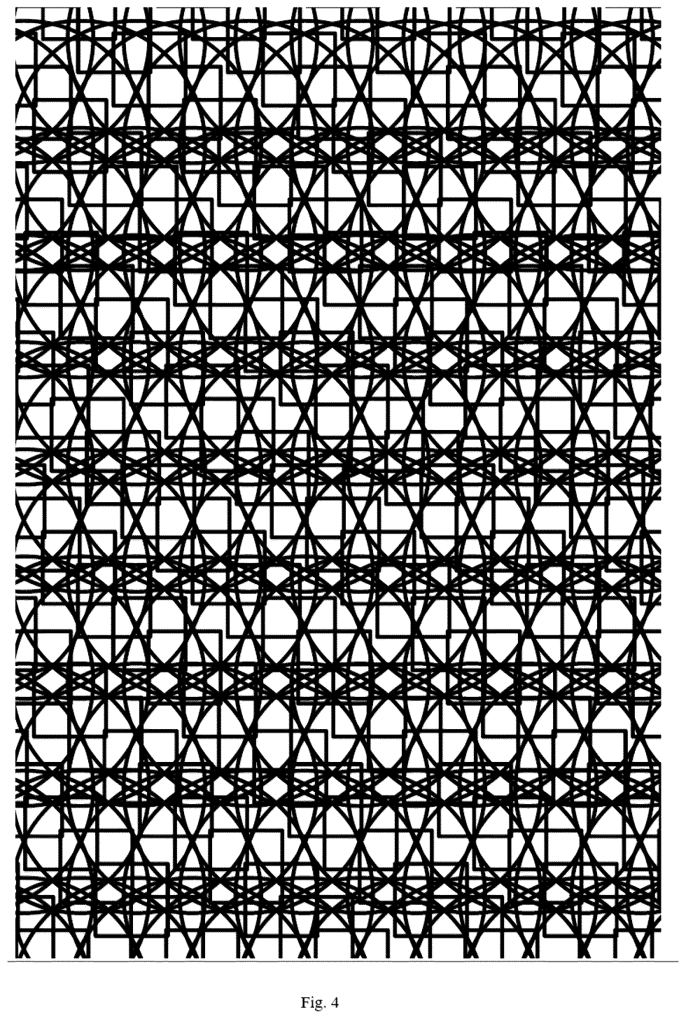

FIG. 4 illustrates an embodiment of the present invention and depicts a barcode blocking poly bag with a heavy ornamental design in the size of 14×20 inches. Printed on the bag is a suffocation warning and printed instructions.

Modifications and substitution by one of ordinary skill in the art are considered to be within the scope of the present invention, which is not limited except by the following claims.

What is claimed is:

1. A barcode blocking poly bag comprising:
a poly bag onto which is printed a design sufficient to block the scanning of the barcode or other code affixed to the item or items contained within;
such poly bag being sufficiently transparent to visually identify the item or items contained within.

2. A barcode blocking poly bag according to claim 1 where:
a portion of the bag is opaque.

3. A blocking bag for the shipment of goods containing a scannable code comprising:
a bag onto which is printed a design sufficient to prevent the scanning of a scannable code affixed to the item or items contained within;
such bag being sufficiently transparent to identify the item or items contained within.

4. A blocking bag according to claim 3 where:
a portion the bag is opaque.

5. A bag for the shipment of goods containing a scannable code comprising:
a bag with a design sufficient to prevent the scanning of a scannable code on the item or items contained within;
such bag being sufficiently transparent to identify the item or items contained within;
where a scannable code affixed to the bag can be scanned without scanning a code on the item or items within the bag.

6. A bag according to claim 5 where:
a portion the bag is opaque.
